(19) United States
(12) Patent Application Publication
(10) Pub. No.: US 2026/0054310 A1
(43) Pub. Date: Feb. 26, 2026

(54) MANUFACTURING METHOD OF CLAMP BODY AND PRODUCT THEREOF

(71) Applicant: EHOMA INDUSTRIAL CORPORATION, Taichung City (TW)

(72) Inventor: Chun-Huan CHUANG, TAICHUNG CITY (TW)

(73) Assignee: EHOMA INDUSTRIAL CORPORATION, Taichung City (TW)

(21) Appl. No.: 18/814,800

(22) Filed: Aug. 26, 2024

(51) Int. Cl. B21J 5/02; B25B 5/16

(52) U.S. Cl. CPC B21J 5/02; B25B 5/16

(57) ABSTRACT

A manufacturing method of clamp body includes following steps: material preparing: preparing a long metal blank; bending: bending the metal blank into an L shape to form a semi-finished product having a long stem and a short stem connected thereto; hot forging: hot forging the short stem of the semi-finished product to form a recess on two sides of the short stem, respectively; and heat treating: heat treating the hot forged semi-finished product to obtain a clamp body. With such manufacturing steps, a lightweight clamp body is obtained.

### BACKGROUND OF THE INVENTION

### 1. Field of the Invention

The present invention relates to manufacturing methods and products of clamp body, and more particularly, to a manufacturing method of a lightweight clamp body and the product thereof.

### 2. Description of the Related Art

Referring to U.S. Pat. No. 10,099,398B2, a Multi-purpose Utility Clamp is disposed, comprising a component engagement member, a guide arm, a first post, and a second post. The component engagement member comprises a threaded shaft. The guide arm has one end disposed on the threaded shaft, with another end thereof disposed on the first post. The first post is slidably connected with the guide arm to clamp objects with different thicknesses. The second post is fixed to one end of the first post, and arranged in perpendicular to the first post by 90 degrees.

The second post has a trapezoid-shaped sectional face, which comprises two conical side faces connected between two end faces. The two end faces are plane, so as to possess a certain structural strength. The second post of the clamp is slidably disposed in the channel of an auxiliary fence, so that the component engagement member imposes a pressure for the fence and the auxiliary fence to achieve a stable clamping function for facilitating the lumber cutting operation.

To maintain a predetermined structural strength, the second post needs a certain volume, such that the second post has to be manufactured and molded with a qualified material. In other words, when the requirement of the structural strength of the second post is increased, the usage amount and volume of the material are correspondingly increased, causing the weight of the clamp to increase as well, which is not favorable for the user to operate, especially when the position of the clamp is frequently moved or adjusted. Also, the increase of the material for the second post production increases the overall cost of the clamp. For the clamp having a certain size, the cost will be more significantly increased.

### SUMMARY OF THE INVENTION

To improve the issues above, the present invention discloses a manufacturing method of clamp body and product thereof. By use of hot forging, a recess is formed on two sides of the short stem of a semi-product. The recesses achieve the goals of lightweighting and material saving, while maintaining the predetermined shape and size, such that the clamp body retains both structural integrity and functionality.

For achieving the aforementioned objectives, the present invention provides a manufacturing method of clamp body, comprising following steps: material preparing: preparing a long metal blank; bending: bending the metal blank into an L shape to form a semi-finished product having a long stem and a short stem connected thereto; hot forging: hot forging the short stem of the semi-finished product to form a recess on two corresponding sides of the short stem, respectively; and heat treating: heat treating the hot forged semi-finished product to obtain a clamp body.

For achieving the aforementioned objectives, the present invention further provides a clamp body, comprising a long stem and a short stem connected thereto, wherein the short stem is provided with two recesses which are extruded to form on two corresponding sides of the short stem through the process of hot forging.

The clamp body manufactured through the aforementioned method achieves advantages of lightweight and material saving. By forming the recesses on two sides of the short stem through hot forging, the present invention not only reduces the material usage, but also preserves the original shape and sizes, ensuring the structural integrity and functionality of the clamp body.

### BRIEF DESCRIPTION OF THE DRAWINGS

FIG. 1 is a flow chart of the manufacturing method in accordance with an embodiment of the present invention.

FIG. 2 is a schematic view of the steps of the hot forging process in accordance with an embodiment of the present invention.

FIG. 3 is a schematic view of the upper mold used in the present invention.

FIG. 4 is a schematic view of the lower mold used in the present invention.

FIG. 5 is a perspective view of the clamp body manufactured through the method of the present invention.

FIG. 6 is a cross-sectional view taken along line 6-6 in FIG. 5.

FIG. 7 is a cross-sectional view taken along line 7-7 in FIG. 5.

### DETAILED DESCRIPTION OF THE INVENTION

The aforementioned and further advantages and features of the present invention will be understood by reference to the description of the preferred embodiment in conjunction with the accompanying drawings where the components are illustrated based on a proportion for explanation but not subject to the actual component proportion.

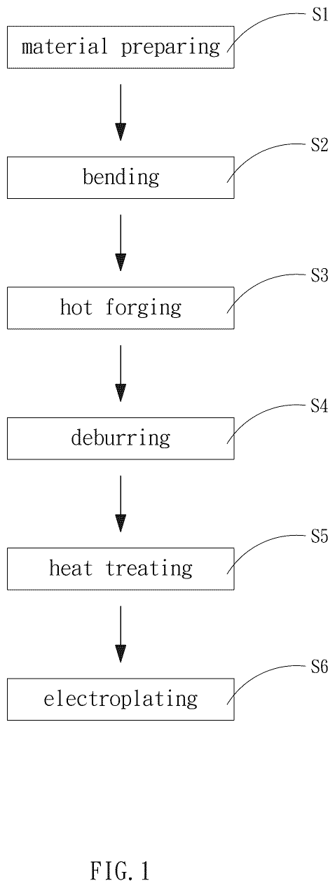

Referring to FIG. 1, the present invention discloses a manufacturing method of clamp body, comprising following steps: material preparing S1, bending S2, hot forging S3, deburring S4, heat treating S5, and electroplating S6.

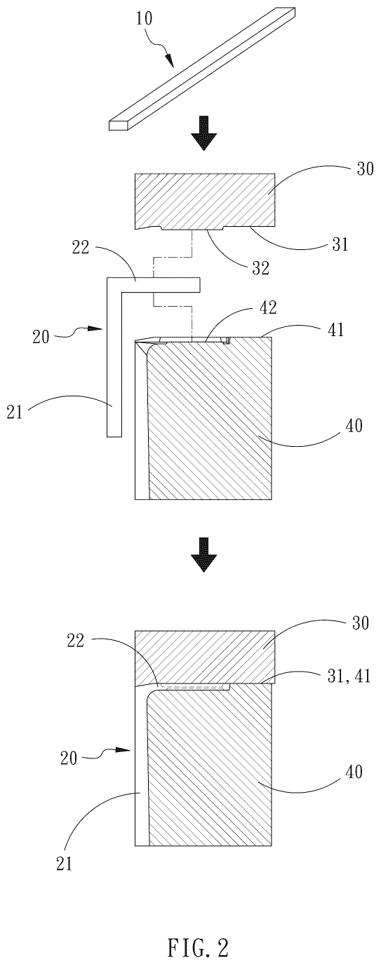

In the step of material preparing S1, a long metal blank 10 is prepared, as shown in FIG. 2. The metal blank 10 was subjected to a drawing process and a cutting process to achieve an appropriate size. The cutting process is carried out by a metal sawing machine.

In the step of bending S2, the metal blank 10 is bent into an L shape, forming a semi-finished product 20 having a long stem 21 and a short stem 22 connected thereto. The metal blank 10 is bent by use of a hydraulic press.

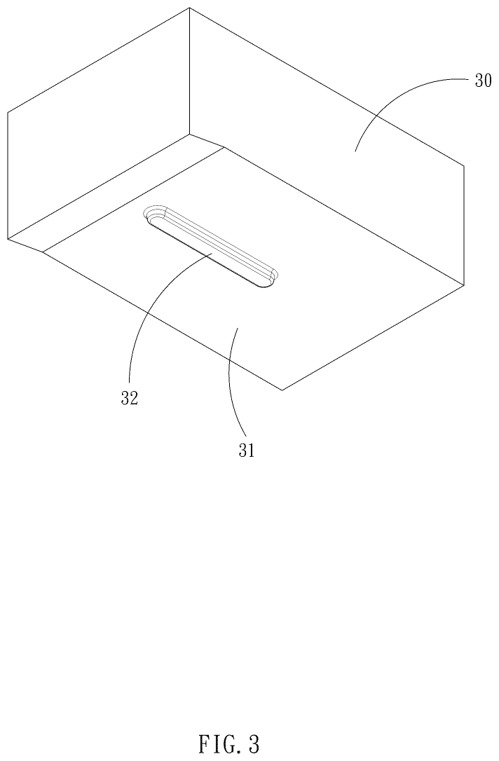

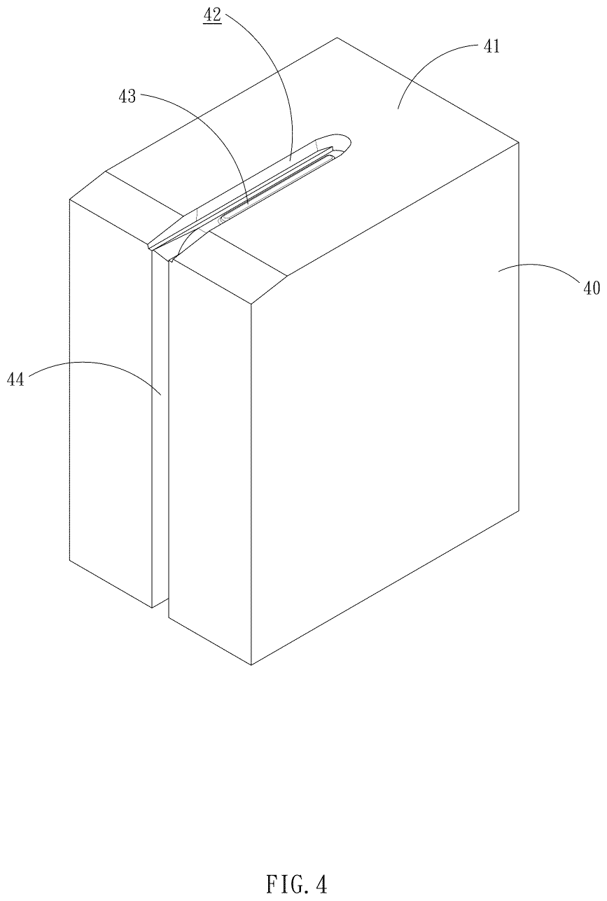

In the step of hot forging S3, the short stem 22 of the semi-finished product 20 hot forged. The short stem 22 is extruded to form a recess 23 on two corresponding sides thereof. Therein, referring to FIG. 2, FIG. 3, and FIG. 4, the short stem 22 is placed between an upper mold 30 and a lower mold 40 to undergo the hot forging process. The upper mold 30 has a first combination face 31, and the lower mold 40 has a second combination face 41 facing the first combination face 31. The first combination face 31 has a first long protrusion 32. The second combination face 41 has a concave cavity 42. The cavity 42 has a second long protrusion 43 disposed on the bottom part thereof, and a side cavity 44 arranged on one side thereof in communication therewith, to receive the long stem 21, so as to facilitating the hot forging process. During the hot forging process, the short stem 22 is heated to a temperature ranging from 870 degrees Celsius to 1100 degrees Celsius. Subsequently, the short stem 22 is placed between the upper mold 30 and the lower mold 40, such that the short stem 22 is extruded by the combined upper mold 30 and the lower mold 40 to form the two recesses 23.

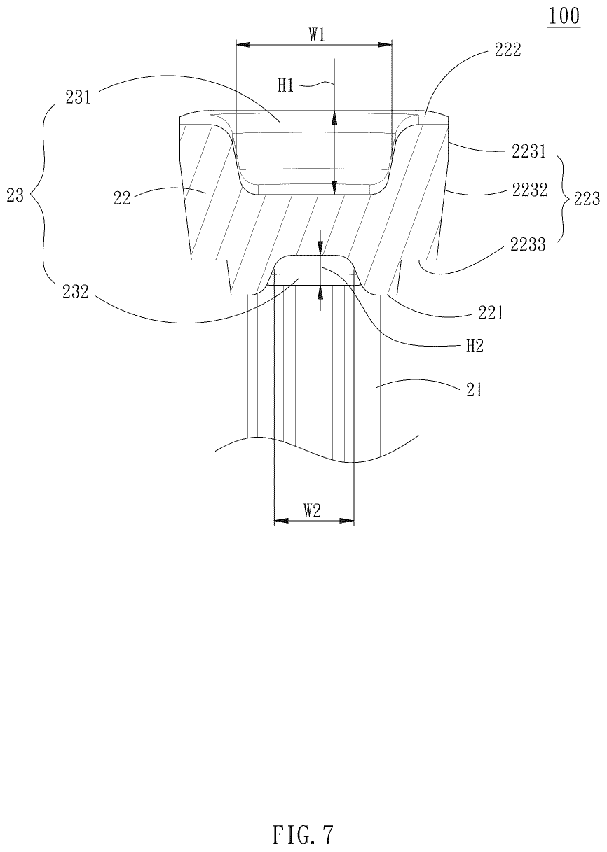

Referring to FIG. 7, in the embodiment, the short stem 22 comprises a clamping face 221 and an opposite outer side face 222, with two side wall faces 223 connected between the clamping face 221 and the outer side face 222. The two recesses 23 are formed on the clamping face 221 and the outer side face 222, respectively.

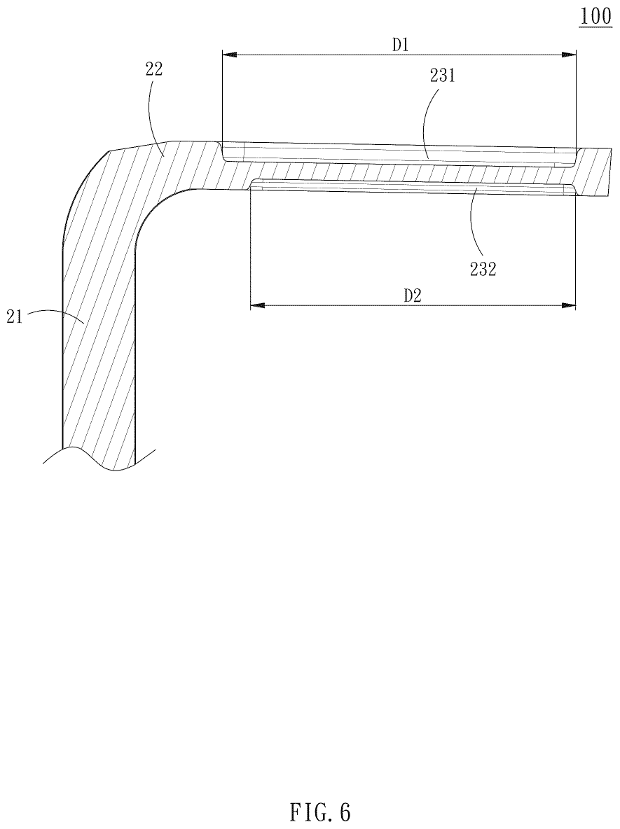

Referring to FIG. 6 and FIG. 7, in the embodiment, the two recesses 23 include a first recess 231 and a second recess 232, wherein the first recess 231 is disposed on the outer side face 222, the second recess 232 is disposed on the clamping face 221, and the first recess 231 is not in communication with the second recess 232. The first recess 231 has a first length D1, a first width W1, and a first depth H1; the second recess 232 has a second length D2, a second width W2, and a second depth H2. The first length D1 is larger than the second length D2, the first width W1 is larger than the second width W2, and the first depth H1 is larger than the second depth H2. In other words, in the embodiment, the size of the first recess 231 is larger than the size of the second recess 232. In another embodiment, the size of the first recess 231 is allowed to be smaller or equal to the size of the second recess 232.

In the embodiment, each of the two side wall faces 223 has a plane face 2231, a conical side face 2232, and a step part 2233. The plane face 2231 is connected between the outer side face 222 and the conical side face 2232; the step part 2233 is connected between the clamping face 221 and the conical side face 2232. The length of each plane face 2231 is smaller than the length of each conical side face 2232. Therefore, through the sectional face of such structure, the short stem 22 is able to cooperate with a groove having a matching sectional face, such as the channel of the auxiliary fence of the abovementioned cited patent.

Therein, the semi-finished product 20 undergoes a volume reduction rate from 10% to 30% through the hot forging process. Though the formation of the two recesses 23, the semi-finished product 20 is lightweighted. Additionally, the shape and size of the short stem 22 still meets the predetermined expectation, thereby maintaining the overall structure while preserving the existing structural strength without affecting the functionality.

In the step of deburring S4, the semi-finished product 20 is deburred, improving the convenience of user gripping during operation.

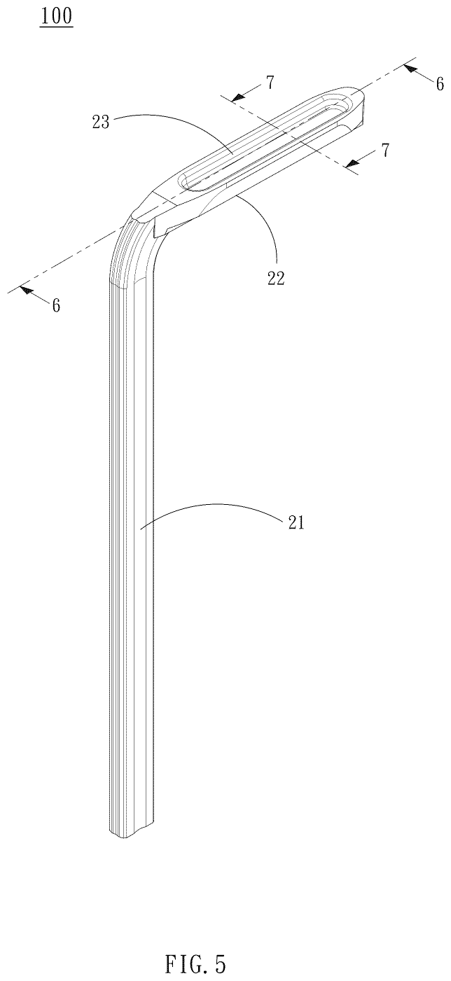

In the step of heat treating S5, the hot forged semi-finished product 20 undergoes the heat treating process to form a clamp body 100, as shown by FIG. 5. The heat treated clamp body 100 has an improved mechanical performance.

In the step of electroplating S6, the heat treated clamp body 100 undergoes an electroplated process, so as to prevent the metal oxidation (such as rusting) and improve the appearance of the clamp body 100.

With the foregoing method, compared with conventional technique, the present invention applies a metal material (section steel) having a smaller size to manufacture the clamp body 100, and the clamp body 100 is accordingly formed to have the dimensions of similar to that using a larger sized metal material, so as to maintain the size and mechanical performance of the product. Furthermore, the formation of the recesses 23 not only saves the material cost, but also improves the production efficiency and cost-effectiveness.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A manufacturing method of clamp body, comprising:
material preparing: preparing a long metal blank;
bending: bending the metal blank into an L shape to form a semi-finished product having a long stem and a short stem connected thereto;
hot forging: hot forging the short stem of the semi-finished product to form a recess on two corresponding sides of the short stem, respectively; and
heat treating: heat treating the hot forged semi-finished product to obtain a clamp body.

2. The manufacturing method of claim 1, wherein the metal blank is prepared through a drawing process and a cutting process; the semi-finished product undergoes a deburring step before the heat treating step; the clamp body undergoes an electroplating step after the heat treating step.

3. The manufacturing method of claim 1, wherein during the hot forging step, the short stem is placed between an upper mold and a lower mold to undergo a hot forging process; the upper mold has a first combination face, and the lower mold has a second combination face; the first combination face has a first long protrusion; the second combination face has a concave cavity, and the cavity has a second long protrusion disposed on a bottom part thereof; when the short stem is placed between the upper mold and the lower mold, the short stem is extruded by the combined upper mold and the lower mold to form the two recesses.

4. The manufacturing method of claim 3, wherein the short stem comprises a clamping face and an opposite outer side face, with two side wall faces connected between the clamping face and the outer side face; the two recesses are formed on the clamping face and the outer side face, respectively.

5. The manufacturing method of claim 4, wherein the two recesses include a first recess and a second recess; the first recess is disposed on the outer side face, the second recess is disposed on the clamping face, and the first recess is not in communication with the second recess; the first recess has a first length, a first width, and a first depth; the second recess has a second length, a second width, and a second depth; the first length is larger than the second length, the first width is larger than the second width, and the first depth is larger than the second depth.

6. The manufacturing method of claim 5, wherein each of the two side wall faces has a plane face, a conical side face, and a step part; the plane face is connected between the outer side face and the conical side face; the step part is connected between the clamping face and the conical side face; a length of each plane face is smaller than a length of each conical side face.

7. The manufacturing method of claim 1, wherein the semi-finished product has a volume reduction rate from 10% to 30% caused by the hot forging step.

8. A clamp body, comprising:
a long stem; and
a short stem connected to the long stem, the short stem being extruded through a hot forging process to form a recess on two corresponding sides of the short stem.

9. The clamp body of claim 8, wherein the short stem comprises a clamping face and an opposite outer side face, with two side wall faces connected between the clamping face and the outer side face; the two recesses are formed on the clamping face and the outer side face, respectively.

10. The clamp body of claim 9, wherein the two recesses include a first recess and a second recess; the first recess is disposed on the outer side face, the second recess is disposed on the clamping face, and the first recess is not in communication with the second recess; the first recess has a first length, a first width, and a first depth; the second recess has a second length, a second width, and a second depth; the first length is larger than the second length, the first width is larger than the second width, and the first depth is larger than the second depth.

11. The clamp body of claim 10, wherein each of the two side wall faces has a plane face, a conical side face, and a step part; the plane face is connected between the outer side face and the conical side face; the step part is connected between the clamping face and the conical side face; a length of each plane face is smaller than a length of each conical side face.
